(19) United States
(12) Patent Application Publication
(10) Pub. No.: US 2010/0090431 A1
(43) Pub. Date: Apr. 15, 2010

(54) WHEEL SUSPENSION

(75) Inventors: Simon Aramah, Osnabruck (GB); Knut Heidsieck, Bunde (DE); Felix Haeusler, Osnabruck (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/519,013

(22) PCT Filed: Dec. 4, 2007
(86) PCT No.: PCT/DE2007/002178

§ 371 Date: Jun. 12, 2009

(30) Foreign Application Priority Data
Dec. 21, 2006 (DE) 10 2006 061 975.7

(51) Int. Cl. B60G 21/055

(52) U.S. Cl. 280/124.106

(57) ABSTRACT

A wheel suspension of a motor vehicle with a two-part wheel carrier (2) that supports a vehicle wheel (1) is proposed, whose first part (3) is articulated to a second part (4), at least one compensation means (5, 6) being provided for connecting the first part (3) of the wheel carrier (2) to the second part (4) of the wheel carrier (2).

According to the invention, the vehicle wheel (1) is actively connected by a stabilizer (7) to a vehicle wheel on the opposite side of the vehicle as viewed in the transverse direction of the motor vehicle. The stabilizer (7) is articulated to the compensation means (5, 6).

This application is a National Stage completion of PCT/DE2007/002178 filed Dec. 4, 2007, which claims priority from German patent application serial no. 10 2006 061 975.7 filed Dec. 21, 2006.

### FILED OF THE INVENTION

The invention concerns a wheel suspension.

### BACKGROUND OF THE INVENTION

The wheel suspension system of a motor vehicle is decisively important, especially in relation to comfort and safety. Accordingly, factors that interfere with the wheel suspension must be compensated in the best possible way.

When driving round a curve, as a result of centrifugal force, the body of a vehicle tends to tilt in a manner referred to as rolling. This causes the vehicle body to move toward the outside of the curve. During this, the weight of the vehicle is transferred predominantly onto the vehicle wheels on the outside of the curve, while the load on the vehicle wheels on the inside of the curve is reduced to the same extent. The tilting of the wheels relative to the road surface, occurring in particular at the wheels on the outside of the curve and referred to as “camber”, can lead to premature wear because of the greatly increased loading of the vehicle's tires. It has also been found that owing to this camber of the vehicle wheels, the lateral force potential is reduced. The camber of a vehicle wheel results in a change of the tire contact area, and because of this the essential grip of the vehicle's wheel on the ground is reduced.

Previously known double transverse control arm axles compensate this camber by controlled action upon the wheel position, in that a negative camber directed the opposite way is produced by virtue of different lengths and/or orientations of the transverse control arms. This, however, has disadvantages when the motor vehicle is driving straight ahead, to be specific, when individual wheels only on one side of the vehicle jounce, as for example when driving over uneven ground.

To reduce the rolling of the vehicle's body when driving round a curve, it is generally known to couple the vehicle wheels opposite one another, as viewed in the transverse direction of the motor vehicle, to one another by means of a stabilizer. Thus, the stabilizer forms a connection between the compressed vehicle wheel on the outside of the curve and the rebounding vehicle wheel on the inside of the curve, the purpose of which is to reduce the jouncing movements. The stabilizers used are mechanical structures consisting, for example, of a bar bent into a U-shape, the open ends of this U-shaped stabilizer being coupled to the wheels of the vehicle. Thus the stabilizer acts as a torsion bar which produces torque directed in opposition to the deflection of the vehicle's wheels.

Furthermore, both active stabilizers equipped with an actuator, and controllable stabilizers are known. The controllable designs in particular are used in off-road vehicles and have a control unit which enables the two halves of the stabilizer to be separated. This separation is necessary for optimum handling of the vehicle on uneven ground. For example, from DE 10 2005 013 769 A1 a controllable stabilizer for a motor vehicle is known, which besides the possibility of decoupling the two halves of the stabilizer, also comprises damping means.

In most cases the stabilizer ends are not attached directly to the vehicle wheel, but rather, via a coupling element which as a rule is a hinged link support. Controllable variants are also known for such link supports. Concerning these, reference may be made to DE 10 2004 025 807 A1, though only as an example.

A special wheel suspension system for a motor vehicle is described in U.S. Pat. No. 6,929,271 B2. This wheel suspension has stabilizers for the correction of wheel positions such as the wheel camber, and provides both a connection between two wheels opposite one another, i.e. the wheels on the two sides of the vehicle, and also a coupling of the front to the rear wheels. In this system dual-action piston-cylinder units are integrated in the stabilizer of the motor vehicle, which compensate for undesired wheel movements for example when driving round a curve. The wheel suspension system known from U.S. Pat. No. 6,929,271 B2 comprises a transverse control arm articulated to a wheel carrier supporting a vehicle wheel.

These known solutions have it in common that the forces acting on the vehicle wheels and the resulting displacements of the vehicle wheels in the sense of camber can be compensated by coupling a plurality of vehicle wheels to one another. However, so far the results of such camber compensation have not been satisfactory. In addition, it has been found that besides the vehicle wheel camber that occurs particularly when driving round a curve, there is also a considerable variation of the track width which has an adverse effect on the driving characteristics of the motor vehicle. The compensating solutions proposed for this additional effect have until now hardly been worth following up.

### SUMMARY OF THE INVENTION

The purpose of the present invention is to provide a wheel suspension system for a motor vehicle, which enables both the camber to be corrected and the track width to be kept constant, and which, so far as possible, can be used with various wheel suspension concepts.

According to the invention a wheel suspension of a motor vehicle, with a wheel carrier made in two parts that supports a vehicle wheel, such that to connect the first part of the wheel carrier to its second part at least one compensation means is provided, has been developed further to the effect that the vehicle wheel has an active connection formed by a stabilizer to a vehicle wheel on the opposite side of the vehicle, as viewed in the transverse direction of the motor vehicle, and the stabilizer is articulated to the compensation means.

The disadvantage of the wheel suspensions known from the prior art with passive kinematic adjustment can be considered to be that, particularly when driving round a curve, the wheel contact point is displaced toward the vehicle. The resulting track width reduction leads to increased rolling of the vehicle body. This recognizably disadvantageous track width change of the vehicle's wheels, as well as the wheel camber, can be compensated for almost completely by a system according to the invention. Even when driving round a curve, the contact area of the vehicle wheel remains optimal. This increases the grip friction between the vehicle wheel and the ground, leading to a considerable increase in safety and, not least, also driving comfort of the motor vehicle.

The improvement compared with conventional wheel suspension systems consists in the stabilizer, which is attached to a divided wheel carrier. The two-part structure of the wheel carrier according to the invention enables the individual parts of the wheel carrier to move relative to one another. The positive vehicle wheel camber that occurs while driving round a curve, i.e. the positioning of the wheel at an angle to the road surface, is changed by this solution to an opposite, i.e. negative camber so that even when driving round a curve the wheel of the vehicle remains almost vertical.

In a first design variant of the invention it is proposed that the wheel suspension comprises a lower compensation means closer to the ground and, at a different height, an upper compensation means. According to the invention, the compensation means serve to couple the parts of the wheel carrier to one another and to enable their relative movement. Furthermore, the compensation means can serve for the connection of other elements essential for the wheel suspension, for example the attachment of transverse control arms. In the present case, it is particularly advantageous for the stabilizer to be attached to the upper compensation means. In such a case, the lever ratios and hence the effect on the vehicle wheel are particularly favorable.

Besides a conventional stabilizer which, as already described earlier, can for example consist of a bar-like element, in a solution according to the invention stabilizers that incorporate active elements can also be used. Accordingly, in a further development of the invention an active stabilizer is provided for use in a wheel suspension according to the invention. By means of the active stabilizer, compared with conventional, mechanical stabilizers, substantially larger forces can be produced, so camber adjustment of the vehicle wheel can be increased. In addition, active stabilizers enable a geometrically advantageous connection of the various components.

The stabilizer associated with the compensation means does not necessarily have to be mounted directly on the compensation means. Rather, in a wheel suspension according to the invention, the stabilizer can advantageously even be fixed indirectly. In that case, the connection between the stabilizer and the compensation means can consist of a coupling element, and a hinged link support can be used as the coupling element. With this solution the kinematic ratios, characteristic of the wheel suspension concerned, can be substantially improved.

In a further design version of the invention, the coupling element is an active coupling element. With active coupling elements, the properties of the wheel suspension can be optimized just as already explained previously in connection with active stabilizers.

As compensation means, rotary joints in particular can be used with advantage, where ‘rotary joint’ is understood to mean a wishbone with three joints or a four-point link arm with four joints. The rotary joints or compensation means constitute elements within the wheel suspension which enable the transfer of movements.

As the joints, ball-and-socket joints, swivel joints or joints with elastic properties can be used. Joints with elastic properties are also known as elastomeric mountings.

Below, the invention is explained in more detail with reference to the attached drawings. The example embodiments shown impose no limitations on the variants represented, but serve only to assist the explanation of some principles of wheel suspensions according to the invention. The same components, or ones of the same type, are given the same index numbers. To be able to clarify the modes of operation according to the invention, the figures only show very much simplified representations of principles, omitting components which are not essential for the invention itself. This, however, does not mean that such components are not present in a wheel suspension according to the invention.

### BRIEF DESCRIPTION OF THE DRAWINGS

The figures show:

FIG. 1: Simplified schematic representation of a first embodiment of a wheel suspension according to the invention, with the vehicle wheel in a non-deflected position;

FIG. 2: The wheel suspension of FIG. 1 deflected under the effect of a lateral force;

FIG. 3: Simplified representation of the principle of another embodiment of a wheel suspension according to the invention, with the vehicle wheel in a non-deflected position;

FIG. 4: Simplified representation of the principle of a third variation of the wheel suspension according to the invention, with no deflection; and

FIG. 5: Simplified representation of the principle of a fourth design of a wheel suspension according to the invention.

### DETAILED DESCRIPTION OF THE PREFERRED EMBODIMENTS

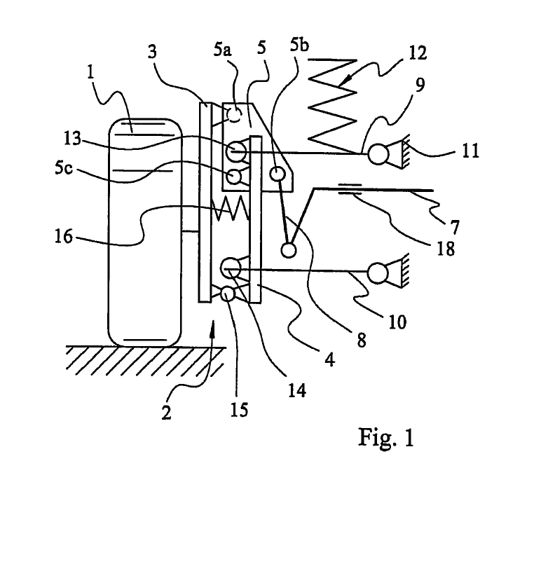

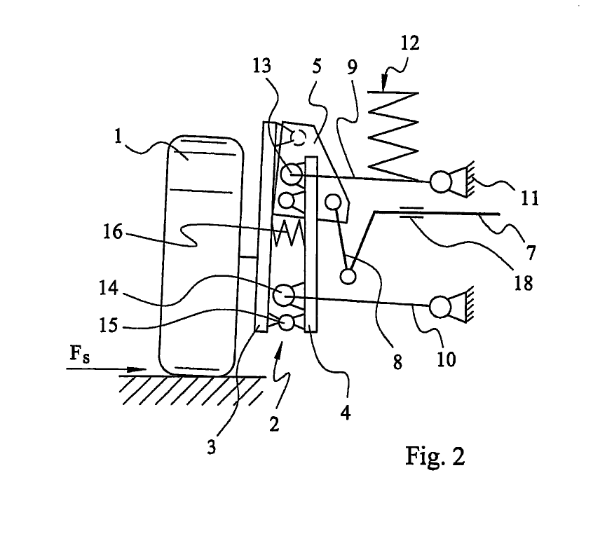

The wheel suspensions according to the present invention shown in FIGS. 1 and 2 represent a simplified structural form corresponding to a first variant, showing a non-deflected wheel suspension in FIG. 1 and the wheel suspension of FIG. 1 deflected under the action of a lateral force F, in FIG. 2. This wheel suspension comprises a vehicle wheel 1 fixed on a wheel carrier indexed 2 as a whole and therefore mounted so that it can rotate. The wheel carrier consists of a first part 3 and a second part 4. The two parts 3 and 4 of the wheel carrier 2 are articulated to one another. For this, they have a direct connection in the form of a hinge 15 and an indirect coupling via a compensation means 5, on which the first part 3 of the wheel carrier 2 is fixed at a joint 5a and the second part 4 of the wheel carrier 2 is fixed at a joint 5c. In addition, the second part 4 of the wheel carrier 2 has two joints 13 and 14 which serve for the attachment of respective transverse control arms 9 and 10. In a manner known per se, the transverse control arms 9, 10 are connected to the motor vehicle and can for example be articulated to the vehicle body 11. The transverse control arm 9 is also associated with a shock absorber 12 to reduce the movements transmitted via the wheel suspension. Overall, the wheel suspension system in FIGS. 1 and 2 conforms with the basic principle known as a double transverse arm wheel suspension. Moreover, between the first part 3 and the second part 4 of the wheel carrier 2 is a spring 16, which restores the two parts 3 and 4 of the wheel carrier 2 to their neutral, starting position. To the upper compensation means 5 of the embodiment variant of a wheel suspension according to the invention shown in FIG. 1, a coupling element 8 is also attached at the joint 5b. The coupling element 8 shown is a hinged link support serving to form an indirect connection of the stabilizer 7 to the wheel suspension. In a manner known per se, for its part the stabilizer 7 is connected to the vehicle body 11 by means of a stabilizer bearing 18. In the non-deflected variant of the wheel suspension in FIG. 1 it should be noted that the vehicle wheel 1 is positioned approximately vertically on the vehicle. A negative camber provided by design in this neutral position must not be present in the configuration according to the invention, so that the wheel is actually orientated vertically. The parts 3 and 4 of the wheel carrier 2 are also approximately parallel to one another. Such a position of the components relative to one another would be adopted for example when the motor vehicle is driving straight ahead.

In contrast, in the embodiment variant of the same structure shown in FIG. 2, the same wheel suspension is represented in a deflected position. Under the effect of a lateral force Fs, which can act on the vehicle wheel 1 for example when it is driving round a curve, the vehicle wheel 1 tends to leave its vertical position and adopt a “positive” camber. However, the wheel suspension according to the invention counteracts this “positive” camber in an optimal manner. As can be seen in FIG. 2, the compression of the vehicle wheel 1 produces a displacement in the stabilizer 7, i.e. a torsion. For its part, this leads to a force that pushes the wheel on the outside of the curve back to its neutral design position. This force is transferred by the link support 8 to the compensation means 5. For optimum design of the system, it is advantageous for the joint 5b on the compensation means to be an elastomeric mounting. By virtue of the force exerted by the stabilizer, the vehicle wheel 1 is pushed toward a position of “negative” camber. That is to say, it is moved in the sense opposite to the positive camber caused by driving round the curve. Accordingly, even when driving round a curve the vehicle wheel 1 adopts a nearly vertical orientation, while the associated movements are taken up within the wheel carrier 2. For this, the parts 3 and 4 of the wheel carrier 2 swivel about the hinge 15 at the bottom of the wheel carrier 2. The effect of the force exerted by the stabilizer 7 and the link support 8 on the compensation means 5 causes the compensation means 5 to pivot about the joint 5c, so that the joint 5b is moved toward the road surface, i.e. downward in the representation shown in FIG. 2. The movement takes place approximately in a circular path. As a result of the effect of the wheel suspension on the upper joint point 5a of the compensation means 5, the first part 3 of the wheel support 2 swivels about the hinge point 15 relative to the second part 4 of the wheel support 2. This enables the vehicle wheel 1 to move in the direction of negative camber.

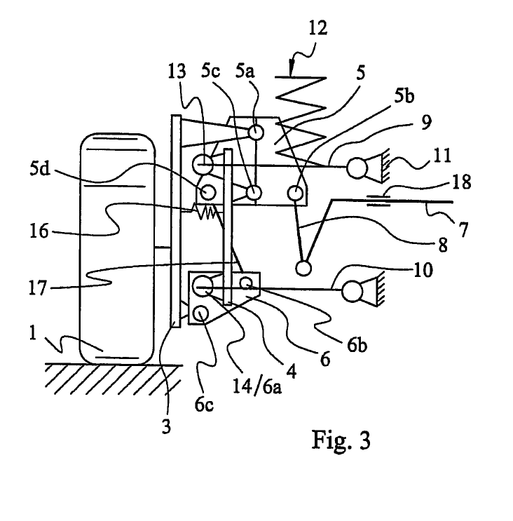

The design variant of a wheel suspension system according to the invention in FIG. 3 is shown in the non-deflected position. In contrast to the wheel suspension already described above, this one has an upper compensation means 5 designed as a four-point link arm and a lower compensation means 6 designed as a wishbone and positioned at a different height. The vehicle wheel 1 is again fixed on the first part 3 of the wheel carrier 2. The first part 3 of the wheel carrier 2 is connected to the first compensation means 5 at the joint point 5a. The second part 4 of the wheel carrier 4 is attached to the four-point link at the joint 5c. The joint 5b, which in this case too is formed as an elastomeric mounting, is connected to the hinged link support 8. In addition, this wheel suspension comprises a further hinged support 17 as a coupling element. This hinged link 17 is fixed on one side to the joint 5d of the upper, four-point link arm and at its other end to the joint 6b of the lower compensation means 6 designed as a wishbone. The joint 6a of the lower compensation means serves for the attachment of the second part 4 of the wheel support 2 in its lower area and forms a connection to the lower transverse control arm 10. Thus, in its function the joint 6a also corresponds to the joint 14 of the embodiment variant in FIGS. 1 and 2. The third joint of the compensation means 6 made as a wishbone is the joint 6c. This serves to connect the first part 3 of the wheel carrier 2, this connection being in the lower area of the wheel carrier part 3. The upper transverse control arm 9 is connected, via the joint 13, to the second part 4 of the wheel carrier 2. The variant of a wheel suspension according to the invention shown in FIG. 3 is a system whose structure is more complex compared with the wheel suspension system explained with reference to FIGS. 1 and 2, but has the advantage that it both enables further optimization of the camber behavior of the vehicle wheel, and reduces the change of the track width of the vehicle wheel 1. With this variant the track width change can be reduced virtually to “zero”, even when the vehicle wheel is steered round a curve at high speed.

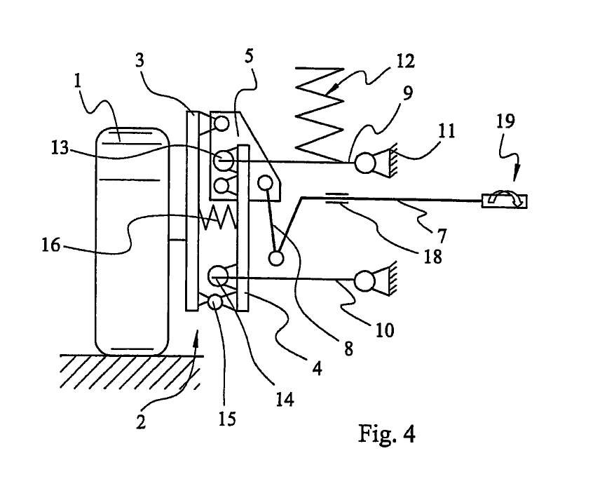

Another, very special design form of a wheel suspension according to the invention is show in FIG. 4. The basic structure of this wheel suspension corresponds to the system already explained in relation to FIGS. 1 and 2. In contrast to that one, however, the stabilizer 7 comprises an actuator 19. With such an embodiment too, the track width change of the vehicle wheel 1 can be reduced almost to zero, which was not possible with wheel suspensions known until now. Compared with the wheel suspension described with reference to FIGS. 1 and 2, with the variant shown in FIG. 4 a controlled and even larger negative camber can be produced since an active stabilizer can exert higher forces than a conventional, mechanical stabilizer. A further advantage of this embodiment variant in FIG. 4 is that it requires fewer structural elements than the mechanical form of a wheel suspension. For example a single, upper compensation means 5 can be sufficient. Consequently, no further, i.e. no lower compensation means 6 is needed. In this example embodiment shown in FIG. 4 the compensating function of the compensation means 6 in FIG. 3 is performed by the active stabilizer 7.

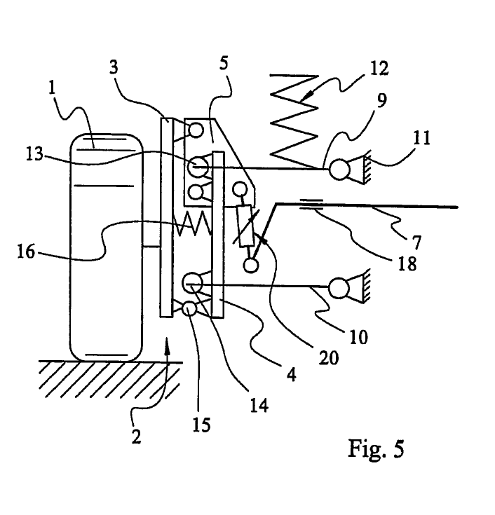

Another embodiment of the invention is shown in FIG. 5. Here too, a wheel suspension such as that already explained with reference to FIGS. 1 and 2 can be used. The basic structure is identical to that system. The difference in the case of the embodiment variant in FIG. 5 is that an active link support 20 is present between the stabilizer 7 and the upper compensation means 5. The compensation means 5 is designed as a wishbone. In the embodiment in FIG. 5 a very simple mechanical system can be used, so dispensing with the need for a lower compensation means 6. For optimum adjustment of the vehicle wheel 1 an upper compensation means 5 is sufficient, in this case again designed as a wishbone.

Of course, a combination of the wheel suspension shown in FIG. 3 with active elements (stabilizer and/or hinged link support) is also possible. The corresponding structural elements have to be adapted at acceptable cost in order to achieve optimum track width change reduction and optimized camber of the vehicle wheel

The principles of the invention described in connection with the figures are naturally not limited to the double transverse control arm axles described here, but can also be applied with structurally different, other wheel suspension systems.

### LIST OF INDEXES

1. Vehicle wheel
2. Wheel carrier
3. First part of the wheel carrier
4. Second part of the wheel carrier
5. Compensation means
6. Compensation means
7. Stabilizer
8. Coupling element
9. Transverse control arm
10. Transverse control arm
11. Vehicle body
12. Shock absorber
13. Joint
14. Joint
15. Joint
16. Spring
17. Coupling element
18. Stabilizer bearing
19. Actuator
20. Active hinged link support
a, b, c, d Joints

1-9. (canceled)

10. A wheel suspension of a motor vehicle with a two-part wheel carrier (2) that supports a vehicle wheel (1), the wheel suspension having a first part (3) articulated to a second part (4),
at least one compensation means (5, 6) being provided for connecting the first part (3) of the wheel carrier (2) to the second part (4) of the wheel carrier (2),
the vehicle wheel (1) being actively connected, by a stabilizer (7), to a vehicle wheel on an opposite side of the vehicle, as viewed in a transverse direction of the motor vehicle, and
the stabilizer (7) being articulated to the at least one compensation means (5, 6).

11. The wheel suspension according to claim 10, further comprising a lower compensation means (6) located closer to a ground and an upper compensation means (5) at a different height therefrom.

12. The wheel suspension according to claim 10, wherein the stabilizer (7) is an active stabilizer.

13. The wheel suspension according to claim 10, wherein a coupling element (8) connects the stabilizer (7) with the at least one compensation means (5, 6).

14. The wheel suspension according to claim 13, wherein a hinged link supports the coupling element (8).

15. The wheel suspension according to claim 13, wherein the coupling element (8) is an active coupling element.

16. The wheel suspension according to claim 10, wherein the compensation means (5, 6) comprises hinged link arms.

17. The wheel suspension according to claim 16, wherein the hinged link arms (5, 6) are, respectively, either wishbones with three joints (a, b, c) or four-point link arms with four joints (a, b, c, d).

18. The wheel suspension according to claim 17, wherein the joints (a, b, c, d) are one of ball-and-socket joints, hinge joints or joints having elastic properties.

19. A wheel suspension for a motor vehicle, the wheel suspension comprising a two-part wheel carrier (2) that supports a vehicle wheel (1), a first part (3) of the two-part wheel carrier (2) is coupled to a second part (4) of the two-part wheel carrier (2) in an articulated manner, lower portions of the first and the second parts (3, 4) are coupled by a hinge (15), a top portion of the first part (3) is pivotably fixed by a first joint (5a) to a compensation means (5), a top portion of the second part (4) is pivotably fixed by a second joint (5c) to the compensation means (5), the top and the bottom portions of the second part (4) are also rigidly fixed, via respective control arms (9, 10), to a body (11) of the vehicle, the compensation means (5) is pivotably coupled by a third joint (5b) to a hinged coupling element (8) which is integrally coupled to a stabilizer (7) that is supported, via a stabilizer bearing (18), to the body (11) of the vehicle.
